(19) United States
(12) Patent Application Publication
(10) Pub. No.: US 2017/0264795 A1
(43) Pub. Date: Sep. 14, 2017

(54) Camcorder Carry

(71) Applicant: Timothy John Perior, Porter Ranch, CA (US)

(72) Inventor: Timothy John Perior, Porter Ranch, CA (US)

(21) Appl. No.: 15/068,459

(22) Filed: Mar. 11, 2016

(51) Int. Cl. H04N 5/225; H04N 7/18

(52) U.S. Cl. CPC H04N 5/2252; H04N 7/18

(57) ABSTRACT

The present invention relates to camcorder carrying device as a means of carrying the camcorder hands free. A significant limitation when using camcorders is they do not have any attachment points for receiving neck or shoulder straps. Virtually every camcorder contains a tripod hole located on the base of the camcorder. The present invention comprises a neck or shoulder strap and a metal or steel plate. The plate has a vertical elongated opening that transverses the entire metal plate. The purpose of the elongated vertical opening is to enable the use of a D-Ring screw to secure the plate to the camcorder. Also, the D-Ring screw is allowed to locate at any locations along the elongated vertical opening and thus the camcorder carrying device of the present invention can fit all brands of camcorders. The plate further has a horizontal opening for receiving the neck or shoulder strap.

### REFERENCE TO RELATED APPLICATIONS

None.

### BACKGROUND OF THE INVENTION

Field of the Invention

This invention relates to an apparatus around a human body as a means of carrying a camcorder or the like hands free.

Description of Related Art

The commercial and non-commercial use of video camcorders is widespread across the world. The first camcorders that were commercialized were for preparing professional video clips for TV or other uses. These large and heavy video cameras were carried around using a significantly strong carrying strap attached to the camera. This strap was typically positioned on the user's shoulder when the camera was not in use, but the camera was being transported or carried to the location that the video clip would be obtained. When the user wanted to shoot a video clip he/she would merely move the camera from the shoulder position to the front view of the user. This is known in the art and is still common today.

Small camcorders were introduced into the commercial marketplace primarily for use by individuals, which were interested in using the camcorder for entertainment purposes or personal events like weddings, birthday parties, graduations, etc. Using a small camcorder typically requires carrying it around during the special or personal events. A significant limitation when using the small “hand Held” camcorders is they can not be conveniently carried around because the camcorder only had a small strap that was intended to be carried (typically around the hand or wrist); this is not a hands-free method of carrying the small camcorder around. The present invention provides the design and manufacturing of a device that enables hanging the camcorder from the neck of the user so that the user has a hands-free carry mechanism, but the hands free carry position does not prohibit the rapid use of the small camcorder. Essentially, the improvement of the present invention, over current technology, is a conveniently hands-free method for carrying the small video camera around such that the video camera can be instantly used by merely picking up the camera, which is anchored around the neck of the user using a strap. The strap also contains a pad where the strap touches the shoulder of the person using the present invention to carry around in a hands-free condition the small camcorder.

### SUMMARY OF THE INVENTION

The present invention provides a carrying device for camcorders or the like. According to one embodiment of the present invention, the carrying device comprises a plate, which has a side facing the camcorder, a side facing away the camcorder, an elongated vertical opening along a vertical midline of the plate, and an elongated horizontal opening near a top of the plate; an anchoring component, which has a threaded stem and a head for anchoring the plate through the vertical opening to the underside of the camcorder; and an adjustable strap adapted to a variety of size of people who carry the camcorder around their neck or should. According to one embodiment, the elongated vertical opening has a depth that extends through an entire thickness of the plate and a width slightly larger than the diameter of the threaded stem of the anchoring component for receiving the anchoring component and allowing the threaded stem of the anchoring component to penetrate through and into the tripod receptacle of the camcorder to secure the camcorder to the plate. According to one embodiment, the elongated vertical opening has a length long enough to allow the anchoring component to be placed at or slid to any locations that correspond to the tripod's receptacle position of a variety of camcorders. According to another embodiment, the strap contains a shoulder or neck pad to make the user feel more comfortable. According to another embodiment, the camcorder device further comprises an attachment component for attaching the plate to the adjustable strap. According to one embodiment, the metal plate has a rectangular shape. According to another embodiment, the metal plate has any shape other than a rectangular shape. According to one embodiment, the metal plate has an elongated horizontal slot near the top of the plate for receiving the adjustable strap or receiving the attachment component to attach said adjustable strap. According to one embodiment, the plate further has a bend near the top of the plate, which allows the use of a high capacity battery. According to one embodiment, the plate is made from a variety of material including but not limited to metal, alloy of metal or steel. According to one embodiment, the carrying device further comprises a very thin rubber piece attached to the plate on the side facing the camera to keep the steel plate from shifting and from scraping the bottom of the camcorder. According to one embodiment, the camcorder carrying device further comprises a thin elastic material attached to the head of anchoring component on the side facing the steel plate to allow for a firm attachment of the anchoring component to the steel plate. According to one embodiment, the thin elastic material includes but is not limited to a rubber piece. According to one embodiment, the carrying device further comprises an elastic material attached to the border of the vertical slot on the side facing away from the camcorder to allow for a firm attachment of the anchoring component to the plate. According to one embodiment, the elastic material includes but is not limited to a rubber piece. According to another embodiment, the adjustable strap has a component for adjusting 16 the length of the strap. According to one embodiment, the vertical slot is embedded in the steel plate such that the vertical slot begins near the bottom of the steel plate and ends approximately in the middle of the steel plate. According to one embodiment, the anchoring component is a D-Ring screw, of which the head is designed large enough such that the camcorder will sit flat when placed on a surface. According to one embodiment, the head of the D-Ring is about 1 inch in diameter. According to one embodiment, the vertical slot is a lane on the steel plate approximately deep enough to allow the D-Ring screw to slide along the lane. According to one embodiment, the attachment means for attaching the metal plate to the adjustable strap is metal clips.

The present invention substantially improves the ease of use of a small video camcorder by eliminating the hand held strap and substituting with a device which includes (i) a means for anchoring the camcorder to an accessory that allows the small video camcorder to be securely anchored to, and (ii) a strap large enough to put around your neck. Thus, the improvement discovered in the present invention is a device that can securely hold and carry around the small video camcorder in a hands-free mode.

An important feature of the present invention is the elongated vertical opening that enables different size camcorders to be anchored to the camcorder carry device. The elongated opening is located in the middle of the camcorder carry device in a vertical position. The elongated vertical opening is the part of the carrying device that allows the camcorder to be positioned at different locations on the metal plate; this is useful for anchoring different size camcorders to the metal plates.

Another improvement in the use of small video camcorders is that the carrying apparatus is designed to also carry a high capacity battery.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a rear view of the camcorder carrying device having a piece of elastic material on the underside of the head of the D-ring screw according to one embodiment of the present invention.

FIG. 2 is a rear view of the camcorder carrying device having a piece of elastic material around the border of the elongated vertical opening according to one embodiment of the present invention.

FIG. 3 is a side view of a camcorder carrying device of the present invention.

FIG. 4 is a rear view of a camcorder carrying device of the present invention attached to a camcorder.

FIG. 5 is a front view of a camcorder carrying device of the present invention attached to a camcorder and worn on a user.

### DESCRIPTION OF THE PREFERRED EMBODIMENT

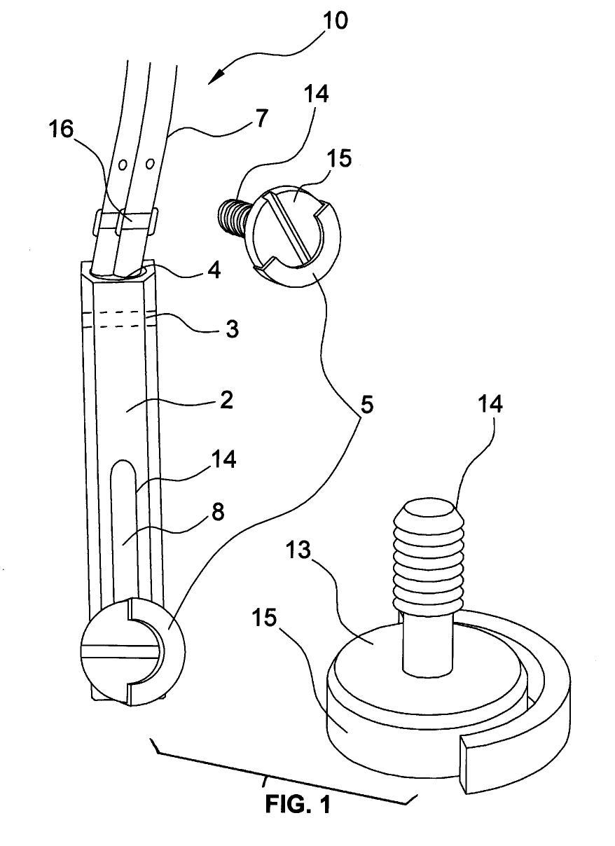

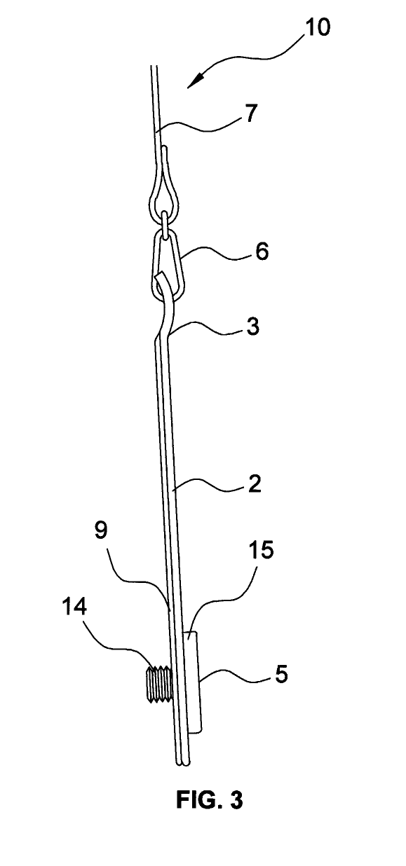

Referring to FIGS. 1-3, there is disclosed a rear view and a side view of a camcorder carrying device 10 according to one embodiment. As depicted in FIGS. 1-3, the camcorder carrier 10 comprises a plate 2; an anchoring component such as a D-Ring screw 5 for anchoring the plate to the underside of the camcorder 20; an adjustable strap 7 adaptable to a variety of size of people who carry the camcorder around their neck or shoulder; an attachment component such as metal clips 6 for attaching the plate 2 to the adjustable strap 7. The plate 2 may be made from a variety of material including but not limited to metal, alloy of metal or steel. The anchoring component has a threaded stem 14 and a head 15 for anchoring the plate 2 through the elongated vertical opening to an underside of the camcorder.

The plate 2 has an elongated vertical opening 8 in the metal plate 2 which starts at the bottom of the metal plate and ends in approximately the middle of the metal plate. The elongated vertical opening 8 has a depth extends through the entire thickness of the plate for receiving the anchoring component and allowing the anchoring component to slide within so that the carrying device can fit all camcorders' tripod receptacle positions The plate 2 further has an elongated horizontal opening 4, which has a depth extends through the entire thickness of said plate for receiving said adjustable strap 7 or attachment component 6 such as metal clips.

The anchoring component 5 includes but is not limited to a D-Ring screw. The D-Ring screw 5 has a male threaded stem 14 that penetrates the vertical opening 8 of the plate 2 into the tripod receptacle 21 located on the base 23 of the camcorder 20. The D-Ring screw 5 has a head 15, which is designed to be large enough so that when the camcorder attached to the carrying device 10 of the present invention the camcorder 20 can still sit flat when placed on a surface. The head 15 of the D-Ring screw 5 is about 1 inch in diameter. The head 15 of the D-Ring screw may have different dimension in order to adapt to a variety of size of camcorders and the like.

The elongated vertical opening 8 has a depth extends through an entire thickness of said plate and a width slightly larger than a diameter of the threaded stem 14 of the D-ring screw for receiving the D-ring screw 5 and allowing said threaded stem 14 of the D-ring screw to penetrate through and into the tripod receptacle 21 of the camcorder 20 to secure said camcorder to said plate 2. The purpose of the elongated vertical opening 8 in the plate is to enable the carry device of the present invention to fit all brands of camcorders and the like. Therefore, the elongated vertical opening 8 has a length long enough to allow the D-ring screw to be placed at or slided to any locations that correspond to the tripod's receptacle position of a variety of camcorders.

The metal plate 2 also comprises a bend 3 in the metal plate wherein the bend 3 in the metal plate is located approximately 1 inch from the top of the metal plate. The bend 3 in the plate allows for attaching or anchoring a high capacity battery.

The adjustable strap 7 to be hung from the neck of the user is attached to the plate 2, which is anchored to the camcorder 20 using a D-Ring screw so that a user can carry the camcorder around in a hands free mode.

The camcorder carrying device further comprises an attachment means 6 such as metal clips which is a means for attaching or anchoring the steel plate to the strap.

According to one embodiment, the camcorder carrying device further comprises a very thin rubber piece 9 attached to the steel plate 2 on the side facing the camera to keep the steel plate from shifting and from scraping the bottom of the camcorder.

It is known in the art that there already exists in the commercial market, straps and attachment mechanisms, for carrying a camcorder. However, none of these straps utilize a metal plate to hold the camcorder, none of these are designed to fit all brands of camcorders, and none of these straps provide a means for anchoring a high capacity battery to the camcorder carrying device, and none of these straps have a means for attaching a tripod to the camcorder if desired.

The present invention attaches the camcorder to a metal plate which is used to attach the strap. Thus, the strap is not directly connected to the camcorder; instead the strap is connected to the metal plate which is attached to (and holding) the camera through the tripod receptacle on the base of the camcorder.

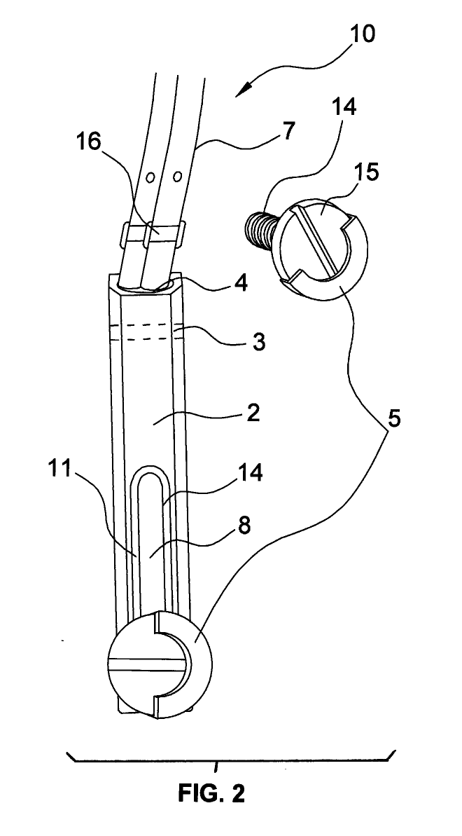

It should be recognized that the metal plate is attached to the camcorder using only one screw. The D-Ring screw 5 is near the bottom of the plate, but the D-Ring screw 5 can be positioned anywhere in the elongated opening 8 in the steel plate. In use, a user can adjust the location of the D-Ring screw or slide the D-Ring screw within the vertical opening in the metal plate according to the camcorder's tripod receptacle position. Since the camera is anchored to the steel plate in only one position (near the bottom) a means for preventing the movement of the camera on the metal plate was needed. In other words, the one anchor position of the camera to the steel plate must be designed to prevent the camera from pivoting around the steel metal plate. This is why the D-Ring was designed to contain a thin piece of rubber 11 on the underside of the head of D-Ring screw as shown in FIG. 1 so that the rubber is interfaced between the head of D-Ring screw and metal plate and therefor the rubber keeps the anchoring firmer and prevents the camcorder from pivoting around. Alternatively, the rubber piece 13 instead of being placed on the underside of the head of the D-Ring screw, the rubber is attached to the border 12 of the vertical opening as shown in FIG. 2. In this way, the rubber is also interfaced between the D-Ring head and metal plate and therefor the rubber keeps the anchoring firmer and prevents the camcorder from pivoting around.

The strap 7 has a pad 13 around the neck or shoulder portion to keep a user feel comfortable.

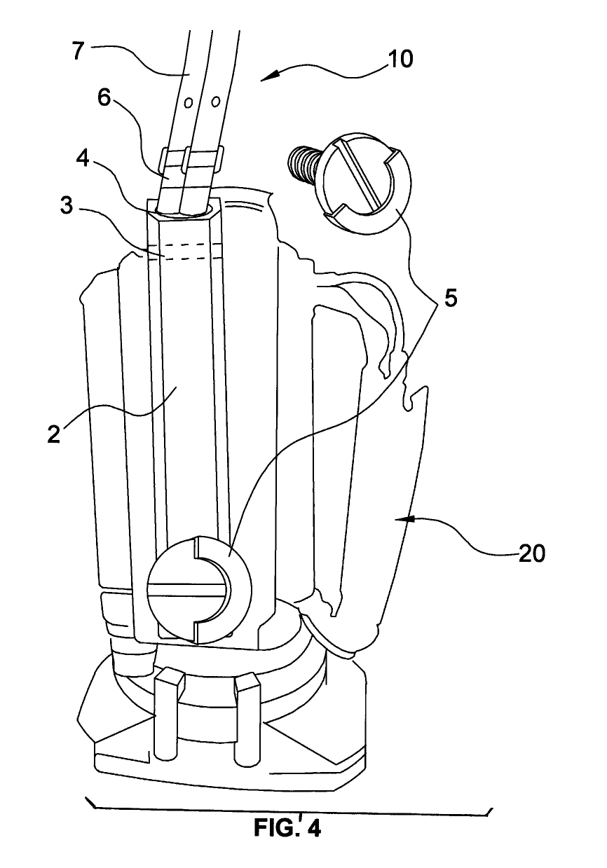

FIG. 4 is a rear view of a camcorder carrying device of the present invention attached to a camcorder.

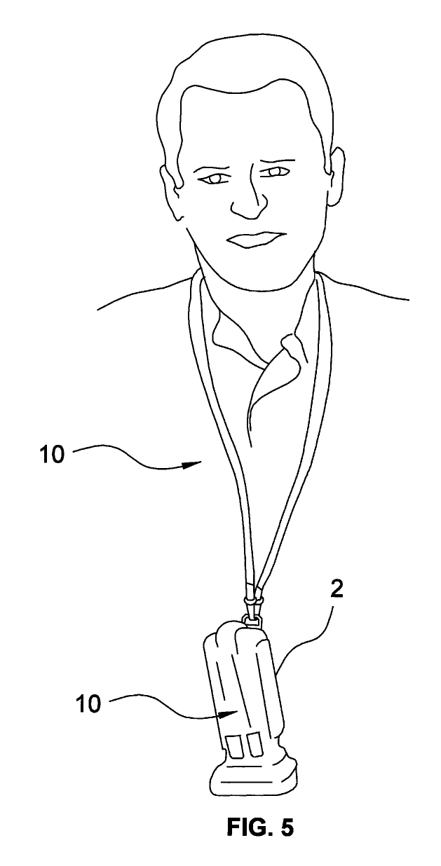

FIG. 5 is a front view of a camcorder carrying device of the present invention attached to a camcorder and worn around a user's neck.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A carrying device for camcorders or the like comprising:
a plate having a side facing the camcorder, a side facing away the camcorder, an elongated vertical opening along a vertical midline of said plate, and an elongated horizontal opening near a top of said plate;
an anchoring component having a threaded stem and a head for anchoring said plate through said elongated vertical opening to an underside of the camcorder;
an adjustable strap adaptable to a variety of size of people who carry the camcorder around their neck or shoulder;
wherein said elongated vertical opening has a depth extends through an entire thickness of said plate and a width slightly larger than a diameter of said threaded stem of said anchoring component for receiving said anchoring component and allowing said threaded stem of said anchoring component to penetrate through and into the tripod receptacle of the camcorder to secure said camcorder to said plate; wherein said elongated vertical opening has a length allowing said anchoring component to be placed at or slid to any locations that correspond to the tripod's receptacle position of a variety of camcorders;
wherein said horizontal opening has a depth extends through the entire thickness of said plate for receiving said adjustable strap or attachment component.

2. The device according to claim 1, wherein said plate has a bend near the top of said plate, which allows the use of a high capacity battery.

3. The device of claim 1, further comprising a very thin rubber piece attached to said plate on the side facing the camera to keep said plate from shifting and from scraping the underside of the camcorder.

4. The device according to claim 1, further comprising a thin rubber attached to said anchoring means on a side facing said plate to allow for a firm attachment of said anchoring means to said plate.

5. The device according to claim 1, further comprising a thin rubber attached to a border of said vertical opening on the side facing away the camcorder to allow for a firm attachment of said anchoring means to said steel plate.

6. The device of claim 1 further comprising an attachment component for attaching said adjustable strap to said plate.

7. The device according to claim 1 wherein said adjustable strap has a component for adjusting the length of the strap.

8. The device according to claim 1, wherein said elongated vertical opening begins near a bottom of said plate and ends approximately in the middle of said plate.

9. The device according to claim 1, wherein said anchoring component is a D-Ring screw, which has a male threaded stem that penetrates said elongated vertical opening of said plate into the tripod hole located on an underside of the camcorder.

10. The device according to claim 1, wherein said D-Ring screw has a head, which is designed large enough such that the carrying device attached camcorder can sit flat when placed on a surface.

11. The device according to claim 9, wherein said head of said D-Ring is about 1 inch in diameter.

12. The device according to claim 1, wherein said elongated vertical opening is a lane on said steel plate approximately deep enough to allow said D-Ring screw to slide along the lane.

13. The device according to claim 1, wherein said strap has a pad around a neck portion.

14. The device according to claim 1, wherein said plate is a metal plate.

15. The device according to claim 1, wherein said plate is a steel plate.

16. The device according to claim 6, wherein said attachment component is metal clips.
